(19) United States
(12) Patent Application Publication
(10) Pub. No.: US 2002/0188401 A1
(43) Pub. Date: Dec. 12, 2002

(54) Delivery vehicle guide system

(76) Inventor: James S. Bridgeforth, Winchester, VA (US)

Correspondence Address: Michael S. Neustel, Suite No. 4, 2534 South University Drive, Fargo, ND, 58103, US

(21) Appl. No.: 09/858,293

(22) Filed: May 15, 2001

(51) Int. Cl. G01C 21/34

(52) U.S. Cl. 701/213; 701/209

(57) ABSTRACT

A delivery vehicle guide system for assisting an individual operating a delivery vehicle during travel along a delivery route. The delivery vehicle guide system includes a computer system within a housing, a display in communication with the computer system, a global positioning system in communication with the computer system, and a speaker in communication with the computer system. The global positioning system constantly monitors the geographic position of the delivery vehicle during a delivery route. The computer system displays information relating to the delivery route such as the next delivery location, directions to next delivery location, details about a specific delivery location, identification of individual to speak with at a delivery location, and other information relating to the delivery route. An audible sounding of the delivery route information may also be provided in conjunction with the display of such information.

### BACKGROUND OF THE INVENTION

1. Field of the Invention

The present invention relates generally to guide systems and more specifically it relates to a delivery vehicle guide system for assisting an individual operating a delivery vehicle during travel along a delivery route.

2. Description of the Prior Art

Delivery routes for the delivery of goods have been in usage for years. Delivery routes are typically very predictable in that they do not frequently change. Delivery routes have a predetermined “order” of delivery that are utilized for significant periods of time without change. A driver of a delivery vehicle typically becomes very familiar with the delivery route and the individuals/businesses deliveries are to be made to.

However, when the regular driver of the delivery vehicle is absent and a new driver is required, the delivery route can become challenging to the new driver requiring extensive training/guidance by a supervisor. The training required by a supervisor can be relatively burdensome for a delivery business. In addition, customers are sometimes unhappy when deliveries are not made at their normal times.

Examples of patented devices which are illustrative of the prior art include U.S. Pat. No. 4,325,057 to Bishop; U.S. Pat. No. 5,963,151 to Hubbard; U.S. Pat. No. 5,973,619 to Paredes; U.S. Pat. No. 6,057,785 to Guthrie; U.S. Pat. No. 6,006,159 to Schmier.

While these Internet based systems may be suitable for the particular purpose to which they address, they are not as suitable for assisting an individual operating a delivery vehicle during travel along a delivery route. None of the prior art devices and systems provide a convenient means for assisting a delivery person during their travel along a delivery route.

In these respects, the delivery vehicle guide system according to the present invention substantially departs from the conventional concepts and designs of the prior art, and in so doing provides a system primarily developed for the purpose of assisting an individual operating a delivery vehicle during travel along a delivery route.

### SUMMARY OF THE INVENTION

In view of the foregoing disadvantages inherent in the known types of guide systems now present in the prior art, the present invention provides a new delivery vehicle guide system wherein the same can be utilized for assisting an individual operating a delivery vehicle during travel along a delivery route.

The general purpose of the present invention, which will be described subsequently in greater detail, is to provide a new delivery vehicle guide system that has many of the advantages of the guide systems mentioned heretofore and many novel features that result in a new delivery vehicle guide system which is not anticipated, rendered obvious, suggested, or even implied by any of the prior art guide systems, either alone or in any combination thereof.

To attain this, the present invention generally comprises a computer system within a housing, a display in communication with the computer system, a global positioning system in communication with the computer system, and a speaker in communication with the computer system. The global positioning system constantly monitors the geographic position of the delivery vehicle during a delivery route. The computer system displays information relating to the delivery route such as the next delivery location, directions to next delivery location, details about a specific delivery location, identification of individual to speak with at delivery location, and other information relating to the delivery route. An audible sounding of the delivery route information may also be provided in conjunction with the display of such information.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a delivery vehicle guide system that will overcome the shortcomings of the prior art systems.

A second object is to provide a delivery vehicle guide system for assisting an individual operating a delivery vehicle during travel along a delivery route.

Another object is to provide a delivery vehicle guide system that allows an individual unfamiliar with a delivery route to adequately and efficiently operate the delivery route.

An additional object is to provide a delivery vehicle guide system that significantly reduces training time for new delivery personnel.

A further object is to provide a delivery vehicle guide system that may be utilized by various individuals and businesses that have delivery routes such as beverage distributors, bakeries, vending machine companies, package delivery companies and other businesses.

Another object is to provide a delivery vehicle guide system that assists a company in reducing down time when an employee quits, is sick or on vacation.

A further object is to provide a delivery vehicle guide system that provides a step-by-step directional guide.

Another object is to provide a delivery vehicle guide system that provides detailed information relating to a delivery route such as but not limited to location of delivery locations, names of contacts, specific procedures, location on building to make delivery, product to be delivered, special matters, and related information.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a front view of the present invention positioned within a delivery vehicle.

FIG. 2 is a front view of the present invention illustrating an example display.

FIG. 3 is an upper perspective view of the present invention.

FIG. 4 is a block diagram illustrating an exemplary computer system to be utilized within the present invention.

FIG. 5 is a block diagram illustrating the computer system receiving data from the global positioning system (GPS).

FIG. 6 is a flowchart illustrating the operation of the present invention.

FIG. 7 is a flowchart illustrating the operation of the present invention with the usage of an audible alerting system.

### DESCRIPTION OF THE PREFERRED EMBODIMENT

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital video discs), and computer instruction signals embodied in a transmission medium (with or without a carrier wave upon which the signals are modulated). For example, the transmission medium may include a communications network, such as the Internet.

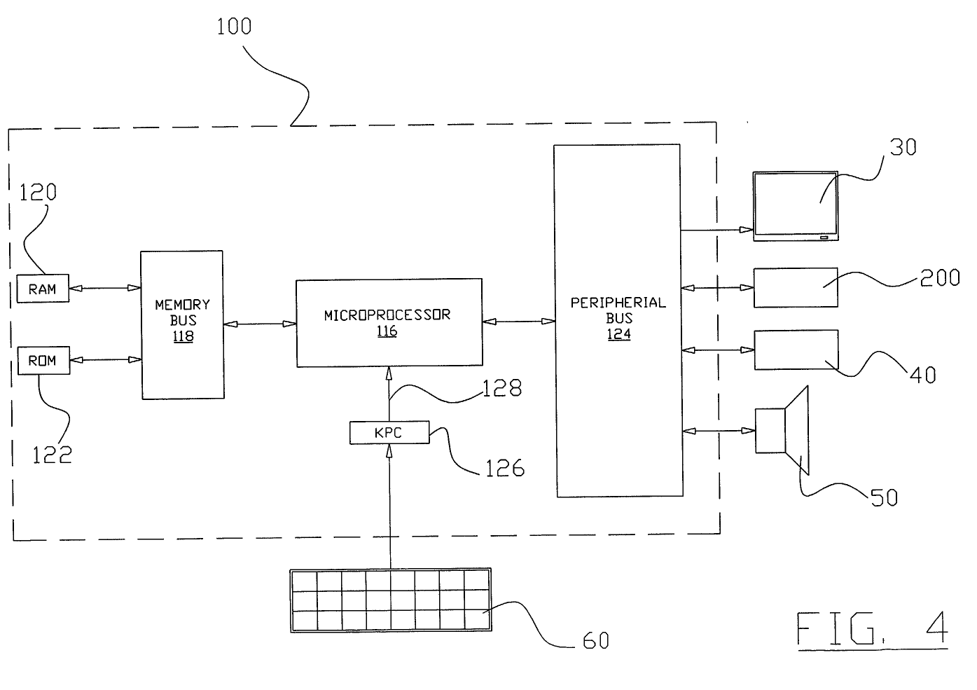

FIG. 4 is a block diagram of an exemplary computer system 100 for practicing the various aspects of the present invention. The computer system 100 includes a display screen (or monitor) 30, a printer 106, a floppy disk drive 108, a hard disk drive 110, a network interface 112, and a keyboard 114. Computer system 100 includes a microprocessor 116, a memory bus 118, random access memory (RAM) 120, read only memory (ROM) 122, a peripheral bus 124, and a keyboard controller 126. Computer system 100 can be a personal computer (such as an APPLE computer, an IBM computer, or one of the compatibles thereof), a workstation computer (such as a SUN MICROSYSTEMS or HEWLETT-PACKARD workstation), or various other types of computers.

The microprocessor 116 is a general-purpose digital processor that controls the operation of the computer system 100. Microprocessor 116 can be a single-chip processor or implemented with multiple components. Using instructions retrieved from memory, microprocessor 116 controls the reception and manipulations of input data and the output and display of data on output devices.

The memory bus 118 is utilized by the microprocessor 116 to access the RAM 120 and the ROM 122. RAM 120 is used by microprocessor 116 as a general storage area and as scratch-pad memory, and can also be used to store input data and processed data. ROM 122 can be used to store instructions or program code followed by microprocessor 116 as well as other data.

Peripheral bus 124 is used to access the input, output and storage devices used A by the computer system 100. In the described embodiment(s), these devices include a display screen 30, a printer device 106, a floppy disk drive 108, a hard disk drive 110, and a network interface 112. A keyboard controller 126 is used to receive input from the keyboard 114 and send decoded symbols for each pressed key to microprocessor 116 over bus 128.

The display screen 30 is an output device that displays images of data provided by the microprocessor 116 via the peripheral bus 124 or provided by other components in the computer system 100. The printer device 106 when operating as a printer provides an image on a sheet of paper or a similar surface. Other output devices such as a plotter, typesetter, etc. can be utilized in place of, or in addition to, the printer device 106.

The floppy disk drive 108 and the hard disk drive 110 can be utilized to store various types of data. The floppy disk drive 108 facilitates transporting such data to other computer systems, and the hard disk drive 110 permits fast access to large amounts of stored data.

The microprocessor 116 together with an operating system operate to execute computer code and produce and use data. The computer code and data may reside on RAM 120, ROM 122, or hard disk drive 120. The computer code and data can also reside on a removable program medium and loaded or installed onto computer system 100 when needed. Removable program mediums include, for example, CD-ROM, PC-CARD, floppy disk and magnetic tape.

The network interface circuit 112 is utilized to send and receive data over a network connected to other computer systems. An interface card or similar device and appropriate software implemented by microprocessor 116 can be utilized to connect the computer system 100 to an existing network and transfer data according to standard protocols.

The keyboard 114 is used by a user to input commands and other instructions to the computer system 100. Other types of user input devices can also be used in conjunction with the present invention. Other types of user input devices can also be utilized in conjunction with the present invention. For example, pointing devices such as a computer mouse, a track ball, a stylus, or a tablet to manipulate a pointer on a screen of the computer system 100.

The present invention can also be embodied as computer readable code on a computer readable medium. The computer readable medium is any data storage device that can store data which can be thereafter be read by a computer system. Examples of the computer readable medium include read-only memory, random-access memory, magnetic data storage devices such as diskettes, and optical data storage devices such as CD-ROMs. The computer readable medium can also be distributed over a network coupled computer systems so that the computer readable code is stored and executed in a distributed fashion.

The delivery vehicle guide system 10 is basically comprised of a computer system 100 within a housing 20, a display 30 in communication with the computer system 100, a global positioning system 200 in communication with the computer system 100, and a speaker 50 in communication with the computer system 100. The global positioning system 200 constantly monitors the geographic position of the delivery vehicle 12 during a delivery route. The computer system 100 displays information relating to the delivery route such as the next delivery location, directions to next delivery location, details about a specific delivery location, identification of individual to speak with at a delivery location, and other information relating to the delivery route. An audible sounding of the delivery route information may also be provided in conjunction with the display 30 of such information.

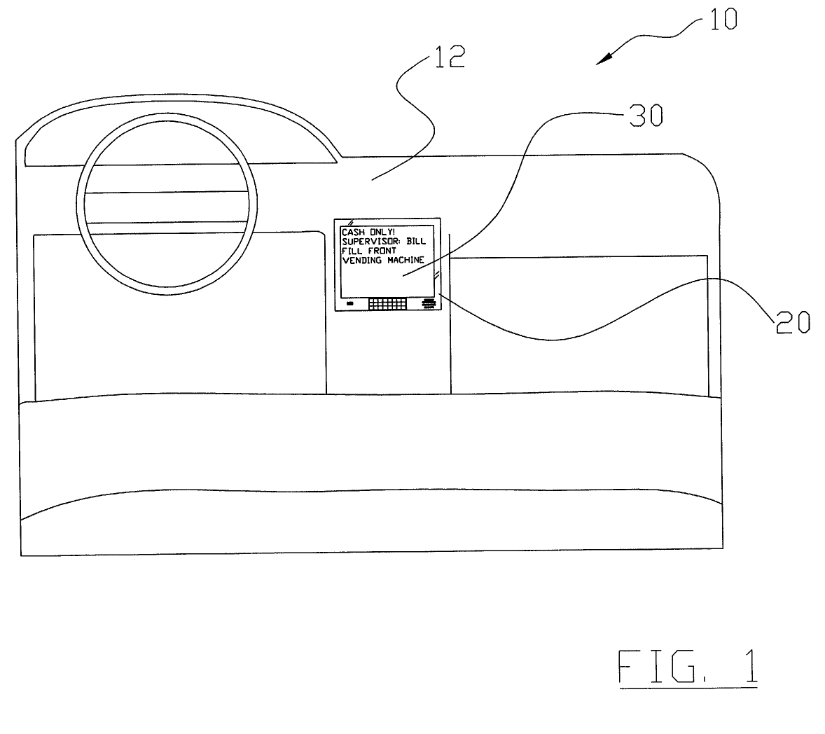

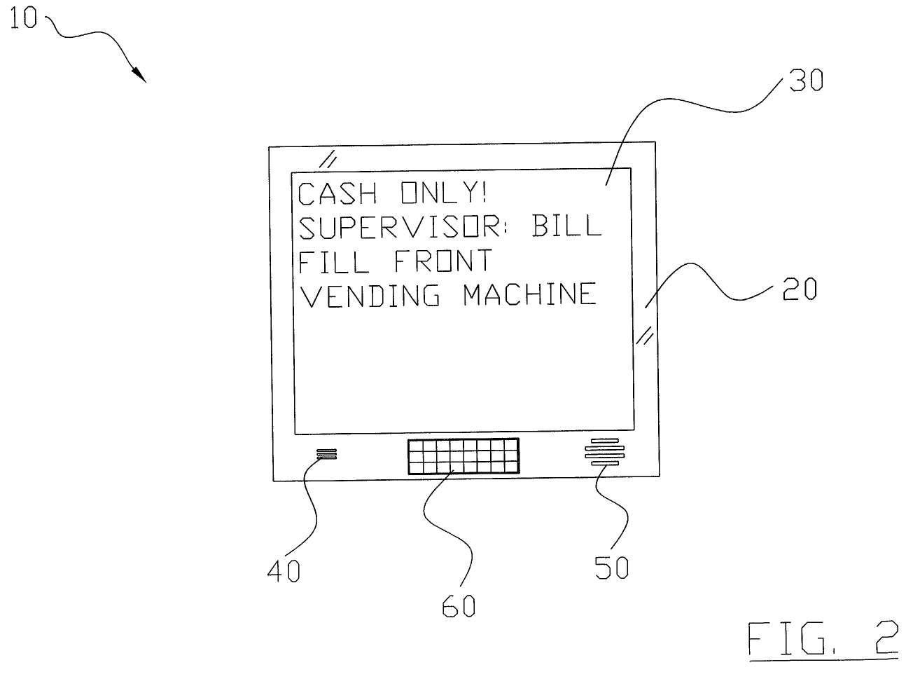

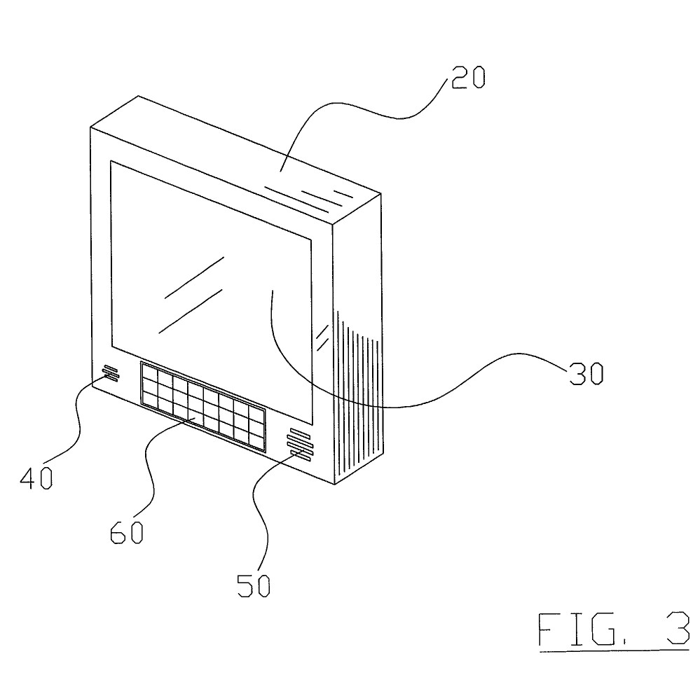

As shown in FIGS. 1 through 3 of the drawings, a display 30 is positioned within the housing 20. The housing 20 may have various shapes and structures as can be appreciated by one skilled in the art. In addition, the housing 20 preferably is attached or attachable to the interior of the delivery vehicle 12 in a conspicuous location for allowing adequate viewing of the display 30. The computer system 100 is positioned within the housing 20 as explained previously.

As further shown in FIGS. 1 through 3 of the drawings, a speaker 50 is positioned within the housing 20 that is in communication with the computer system 100 for emitting audible commands relating to the delivery route. The audible commands may mirror the content shown upon the display 30 or may be additional to the content shown upon the display 30.

A shown in FIGS. 1 through 3 of the drawings, a microphone 40 is positioned within the housing 20 and in communication with the computer system 100 for receiving verbal input from the driver. The driver is able to record verbal statements relating to the delivery route such as information relating to a specific delivery location that may be played back at a later time.

In addition to the microphone 40, a keypad 60 is positioned within the housing 20 and in communication with the computer system 100 for receiving data input relating to the delivery route. The keypad 60 may also be utilized to allow for manual control of the computer system 100 by the driver during travel along the delivery route.

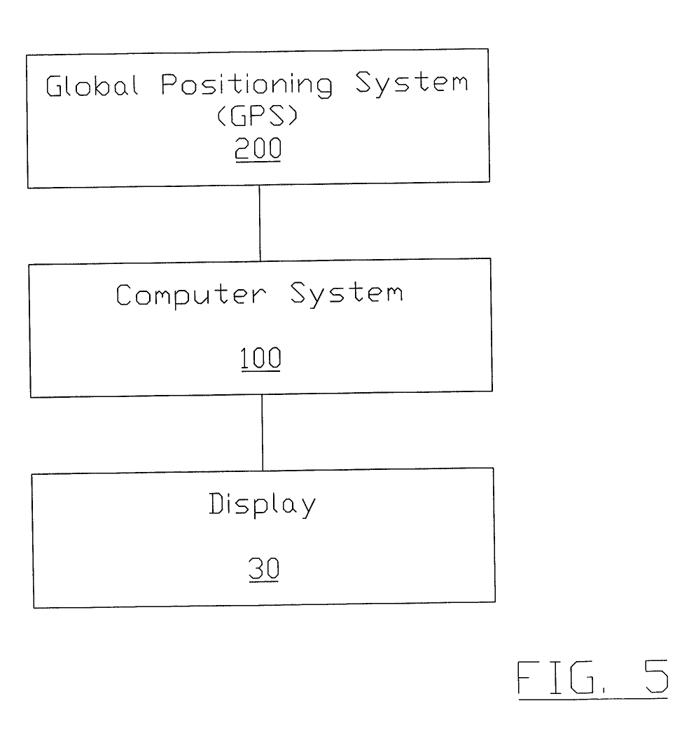

As shown in FIGS. 4 and 5 of the drawings, a global positioning system 200 is in communication with the computer system 100. The global positioning system 200 may be comprised of any well-known global positioning technology for allowing the computer system 100 to constantly monitor the geographic location of the delivery vehicle 12. Global positioning systems are well-known in the art and may be utilized in any known manner by one skilled in the art to construct and utilize the present invention.

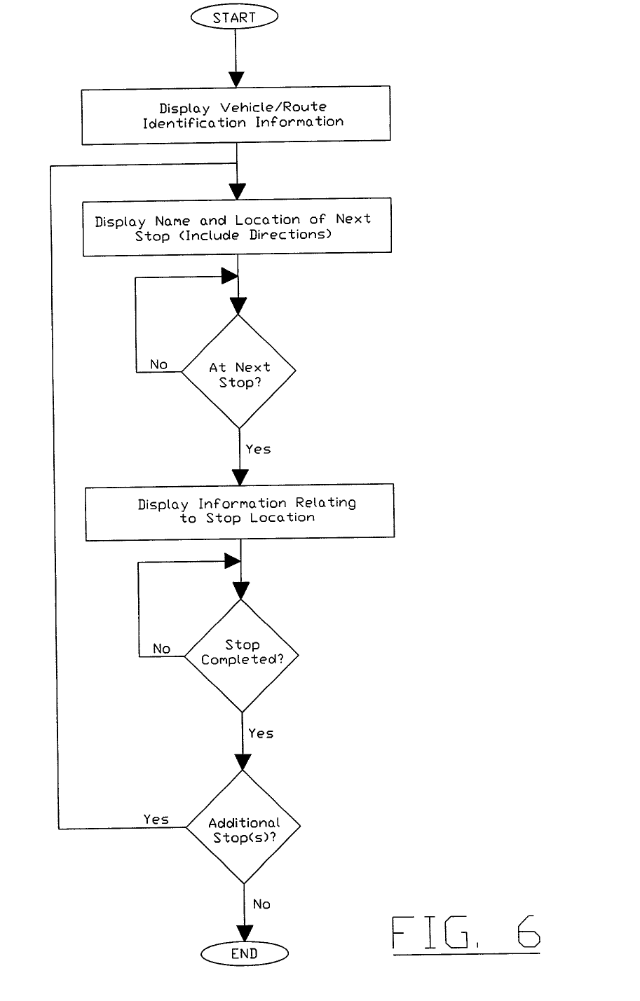

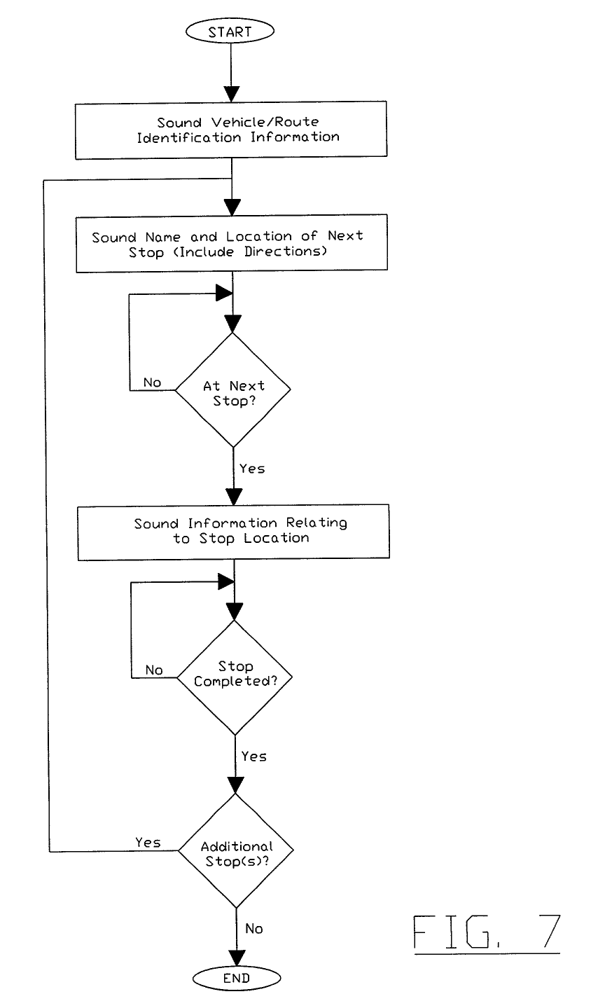

In use, the driver of the delivery vehicle 12 enters the vehicle from a warehouse or other initial position. The driver of the delivery vehicle 12 may enter delivery route identification data to inform the computer system 100 what delivery route will be operated upon. The computer system 100 retrieves the data relating to the delivery route identified and displays the relevant data to the driver such as the identification and location of the next delivery location along with directions as shown in FIG. 6 of the drawings. In addition to displaying the delivery location information upon the display 30, the computer system 100 may emit an audible statement regarding the identification and location of the next delivery location to assist the driver without requiring the driver to view the display 30 as shown in FIG. 7 of the drawings. The computer system 100 constantly monitors the delivery vehicle 12 position utilizing the data received from the global positioning system 200. Specific directions may be provided to the driver while driving to the next delivery location such as turn locations and street identification. When the delivery vehicle 12 is near the first delivery location, the computer system 100 informs the driver that they are approaching the delivery location and provides information relating to the delivery location such as but not limited to the manager name, location upon building to make delivery, goods to be delivered and other relevant information. After the user has delivered the goods at the delivery location, the driver may indicate via verbal or manual input into the keypad 60 that the delivery has been made where after the computer system 100 informs the driver of the next delivery location as shown in FIGS. 6 and 7 of the drawings. This process continues until the entire delivery route has been fulfilled.

As to a further discussion of the manner of usage and operation of the present invention, the same should be apparent from the above description. Accordingly, no further discussion relating to the manner of usage and operation will be provided.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. Additionally, the above disclosure is not intended to limit the invention. The scope of the invention is defined by the appended claims.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Index of Elements for Delivery Vehicle Guide System-PAGE 1

□
□
□
□
□
□
□
□
□
□
□ 10. Delivery Vehicle Guide System
□ 11.
□ 12. Delivery Vehicle
□ 13.
□ 14.
□ 15.
□ 16.
□ 17.
□ 18.
□ 19.
□ 20. Housing
□ 21.
□ 22.
□ 23.
□ 24.
□ 25.
□ 26.
□ 27.
□ 28.
□ 29.
□ 30. Display
□ 31.
□ 32.
□ 33.
□ 34.
□ 35.
□ 36.
□ 37.
□ 38.
□ 39.
□ 40. Microphone
□ 41.
□ 42.
□ 43.
□ 44.
□ 45.
□ 46.
□ 47.
□ 48.
□ 49.
□ 50. Speaker
□ 51.
□ 52.
□ 53.
□ 54.
□ 55.
□ 56.
□ 57.
□ 58.
□ 59.
□ 60. Keypad
□ 61.
□ 62.
□ 63.
□ 64.
□ 65.
□ 66.
□ 67.
□ 68.
□ 69.
□ 70.
□ 71.
□ 72.
□ 73.
□ 74.
□ 75.
□ 76.
□ 77.
□ 78.
□ 79.
□ 100. Computer System
□ 101.
□ 102.
□ 103.
□ 104.
□ 105.
□ 106. Printer
□ 107.
□ 108. Floppy Disk Drive
□ 109.
□ 110. Hard Disk Drive
□ 111.
□ 112. Network Interface
□ 113.
□ 114. Keyboard
□ 115.
□ 116. Microprocessor
□ 117.
□ 118. Memory Bus
□ 119.
□ 120. RAM
□ 121.
□ 122. ROM
□ 123.
□ 124. Peripheral Bus
□ 125.
□ 126. Keyboard Controller
□ 127.
□ 128. Bus
□ 129.
□ 130.
□ 131.
□ 132.
□ 133.
□ 134.
□ 135.
□ 136.
□ 137.
□ 138.
□ 139.
□ 200. Global Positioning System
□
□
□
□
□
□
□
□
□
□
□
□
□
□
□
□
□
□
□
□
□
□
□
□
□
□
□
□
□
□
□
□
□
□
□
□
□
□
□

I claim:

1. A delivery vehicle guide system for assisting a driver of a delivery vehicle in completing a delivery route, comprising:
a housing;
a computer system storing route information relating to a delivery route;
a display within said housing and in communication with said computer system for displaying said route information; and
a keypad within said housing and in communication with said computer system.

2. The delivery vehicle guide system of claim 1, including a global positioning system in communication with said computer system for providing a geographic location of said delivery vehicle wherein said computer system utilizes said geographic location to select specific data from said route information to be displayed.

3. The delivery vehicle guide system of claim 2, including a speaker within said housing and in communication with said computer system for audibly sounding said route information.

4. The delivery vehicle guide system of claim 3, including a microphone within said housing and in communication with said computer system for receiving audible data from said driver to be replayed.

5. The delivery vehicle guide system of claim 4, wherein said route information is comprised of delivery location and delivery identification.

6. The delivery vehicle guide system of claim 5, wherein said route information is further comprised of a directions to said delivery location.

7. The delivery vehicle guide system of claim 6, wherein said route information is further comprised of an identity of contact at said delivery location.

8. The delivery vehicle guide system of claim 7, wherein said route information is further comprised of an identification of goods to be delivered to said delivery location.

9. A method of operating a delivery vehicle guide system for assisting a a driver of a delivery vehicle in completing a delivery route, comprising the steps of:
(a) providing a delivery guide unit having a housing, a computer system, a display, a speaker a microphone, and a global positioning system in communication with one another;
(b) initiating said delivery route;
(c) displaying information relating to a delivery location;
(d) displaying directions to said delivery location;
(e) indicating when said delivery vehicle is near said delivery location;
(f) displaying specific information relating to said delivery location;
(g) delivering goods at said delivery location; and
(h) repeating steps (a) through (g) if additional delivery location exists.

10. The method of operating a delivery vehicle guide system of claim 9, including the step of entering data relating to said delivery location that may be displayed later.

11. The method of operating a delivery vehicle guide system of claim 10, including the step of audibly informing said driver of said specific information.

12. The method of operating a delivery vehicle guide system of claim 11, wherein said specific information is comprised of delivery identification, directions to said delivery location, directions to building location for delivery, and contact information.
